(19) United States
(12) Patent Application Publication
(10) Pub. No.: US 2014/0344905 A1
(43) Pub. Date: Nov. 20, 2014

(54) Message Delivery System

(71) Applicant: Sean P. Sheppard, Ft. Lauderdale, FL (US)

(72) Inventor: Sean P. Sheppard, Ft. Lauderdale, FL (US)

(21) Appl. No.: 14/278,846

(22) Filed: May 15, 2014

Related U.S. Application Data
(60) Provisional application No. 61/823,952, filed on May 16, 2013.

(51) Int. Cl. H04L 29/06

(52) U.S. Cl. CPC H04L 63/08
USPC 726/5

(57) ABSTRACT

A processor-based method for delivering messages to recipients upon the death of a user. User accounts are created by receiving a social security number from a user computer, and storing the social security number in a memory and in association with a given user account. Recipient contact information is received from the user computer, and stored in the memory and in association with the given user account. The messages to be delivered upon the death of the user are also received from the user computer, and stored in the memory and in association with the given user account. A processor, according to a predetermined cyclical time schedule, compares the social security numbers associated with the user accounts to an electronically accessible listing of social security numbers of people who have died. When a match is found between the social security numbers of people who have died and a social security number associated with one of the user accounts, then the messages associated with the user account are sent through an output to the recipients associated with the user account.

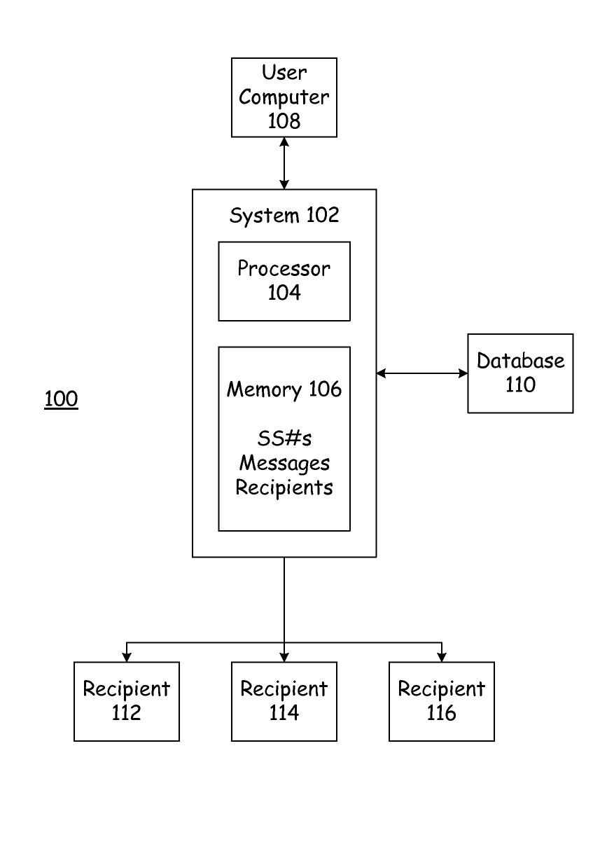

This application claims rights and priority on co-pending U.S. provisional patent application Ser. No. 61/823,952 filed 2013 May 16. This invention relates to the field of message delivery systems. More particularly, this invention relates to automatically delivering a message upon the death of the originator of the message.

### FIELD

### Introduction

When faced with the anticipation of their own death, people tend to have a desire to communicate their final thoughts to others—such as their loved ones. These thoughts often take the form of financial instructions, words of wisdom, instructions on final arrangements, and words of consolation and love.

Unfortunately, many people face death under circumstances that are so sudden that they don't have the opportunity to leave any such messages—either in person or recorded in any other manner. In other situations those to whom the messages would be given are not present and there are no means by which the message could be captured and delivered. However, messaging systems have been developed to provide for the communication of these final thoughts even when such conditions exist.

For example, deathswitch.com provides a service by which users can upload a message that is intended for a list of recipients. Deathswitch.com subsequently sends out repeated email notices to the user. If the user fails to respond to some number of the notices, deathswitch.com presumes the user is dead, and proceeds to send the uploaded message to the recipients on the list. Unfortunately, there are common occurrences that could prevent the user from responding to the notices, which could be misinterpreted by deathswitch.com as the death of the user. Such occurrences include, for example, a change in the user's email address, the notices being inadvertently deleted or sent to a spam folder, or an extended vacation by the user.

Lastpost.com proposes a similar service. Again, however, there is no automated system by which lastpost.com would have definitive confirmation of death in order to send out the messages that had been uploaded. Other such services use proxies or trustees, who must notify the website in the event of the death of the user, after which the website confirms the user's death in some manner.

These services have failed to develop a system in which the user is provided with privacy, while enabling the system to automatically send out, in the event of the user's death, the messages that have been finalized by the user.

What is needed, therefore, is a message delivery system that reduces problems such as those described above, at least in part.

### SUMMARY

The above and other needs are met by a processor-based method for delivering messages to recipients upon the death of a user. User accounts are created by receiving a social security number from a user computer, and storing the social security number in a memory and in association with a given user account. Recipient contact information is received from the user computer, and stored in a memory and in association with the given user account. The messages to be delivered upon the death of the user are also received from the user computer, and stored in a memory and in association with the given user account. A processor, according to a predetermined cyclical time schedule, compares the social security numbers associated with the user accounts to an electronically accessible listing of social security numbers of people who have died. When a match is found between the social security numbers of people who have died and a social security number associated with one of the user accounts, then the messages associated with the user account are sent through an output to the recipients associated with the user account.

In some embodiments the different messages are associated with different recipients within the user account. In some embodiments the messages include email and attachments. In some embodiments the cyclical time schedule is once per week.

According to different aspects of the present invention, an apparatus that accomplishes the method recited above is described, and a program on a computer readable storage medium that instructs a computer to perform the method recited above is also described.

### DRAWING

Further advantages of the invention are apparent by reference to the detailed description when considered in conjunction with the FIGURE, which are not to scale so as to more clearly show the details, which depicts a functional block diagram of a system according to an embodiment of the present invention.

### DESCRIPTION

With reference now to the FIGURE, there is depicted a networked system 100 of computers, including a system 102 according to an embodiment of the present invention. The system 102 includes a processor 104 and a memory 106, along with other components as required to provide the functions described herein. In some embodiments the system 102 is a small computer such as a personal computer, and in other embodiments the system 102 is a large computing system, such as a distributed computing system with many processors and memories.

The system 102 receives information from a user computer 108, with which a user sets up a user account on the system 102. As a part of the account set up process, information about the user is received, such as the social security number of the user, messages and other electronic information that the user desires to have distributed upon his death (collectively referred to as messages herein), and contact information for the recipients of the messages. In some embodiments the messages are exclusively electronic, such as typed messages, scanned documents, digitized photographs, and audio or video recordings, and the contact information is email addresses. All of this information is stored in the memory 106 of the system 102 in association with the user account.

In some embodiments the communication between the various elements of the networked system 100 is accomplish across a globally networked computer information communication system, such as the Internet.

On some predefined schedule, the system 102 checks a database 110 that includes the social security numbers of people who have died. In some embodiments this is the social security death index, and in other embodiments it is the Social Security Administration's master death file. In other embodiments it is another database that contains data on the social security numbers of people who have died.

The information from the database 110 is compared to the social security numbers in the various user accounts on the system 102. When a match is found between a given social security number in an account on the system 102 and a social security number in the database of deceased people, then the system 102 sends the messages associated with the given account to the recipients 112, 114, or 116 associated with the given account. This is accomplished in an unassisted manner, such that the system 102 sends the messages without any human intervention. In this manner, the system 102 maintains the privacy of the user, even after death.

In some embodiments, the system 102 only sends the messages upon the occurrence of the social security number in one of the accounts matching a social security number in the database 110. No other input is used to trigger the sending of the messages in these embodiments. In some embodiments, the system 102 checks the database 110 on some predetermined cyclical time schedule, such as daily, weekly, monthly, yearly, and so forth. In some embodiments, although the cycle can commence at a desired point in time, be stopped for some reason, and then be restarted, the process of checking the database 110 is accomplished according to the schedule, and not based upon some other event or trigger, such as the suspicion that one of the users might have died, or even actual notification of such.

In some embodiments the user can provide a plurality of different messages, which can be sent to a plurality of different recipients. For example, one set of messages can be sent to one set of recipients, and a second set of messages can be sent to a second set of recipients. The two sets of messages can either be exclusive or overlapping, and the two sets of recipients can either be exclusive or overlapping. In other words, the account can be set up such that not all messages need to be delivered to all recipients 112, 114, and 116.

According to one embodiment, a website enables users to register their account utilizing their social security number alone. Once registered, the web-based service allows users to create email messages (with the added benefit of being able to attach to the emails whatever videos, songs, voice recordings of the decedent, links to Internet pages or content, and other attachments they desire) to be sent only in the event of death. The website automatically and periodically checks with the United States Social Security Death Index or Social Security Master Death File, by user social security number, to determine if any user has died. This is the verification process that allows the service to operate with the user's privacy in mind, so that the system is completely autonomous, the user does not need to tell anyone what he or she is doing ahead of time, and there is no need to have any third party involved to confirm death. Upon confirmation of death through the SSDI, the website automatically sends all finished messages in the system under the user's account.

In some embodiments, the user, upon registering for the service, simply provides a social security number and an email address. A name, address, date of birth, or other identifying information is not required. The user creates messages for as many recipients as they would like. The user can upload music, recorded messages, videos, or other data from their own sources, or from third party websites with which the system 102 has affiliate relationships.

In some embodiments the system 102 will appear to the user like an online email system, without any provision for actually sending any messages. Instead, messages can be created, documents or other files attached, recipient lists created, and the messages then stored. The messages are subsequently sent automatically by the system 102 upon the occurrence of the events as described above. Users can log on to the system 102, such as by account name and password, and create new messages, input new recipients, and change or delete existing messages. Any finalized message existing on the system 102 upon occurrence of the user's death as described above will be sent by the system 102.

In some embodiments, before any message is closed by the user, the system 102 will ask whether the message is finalized and ready or still being processed. Messages that are not finalized will not be sent by the system 102, in one embodiment. Users will be allowed to upload anything they would like with their messages, including video footage, audio clips, voice recordings, links to Internet pages or content, photographs, PDF files, and other files. In some embodiments, each social security number is entitled to one account, so that a single user cannot have multiple accounts.

In some embodiments, users will be permitted to pay additional charges for the benefit of having the messages printed and mailed to physical addresses either in lieu of or in addition to the electronic delivery of messages as described herein. Such services would be provided to users to allow for additional peace of mind and assurance that physical mailings will be sent to their recipients.

The system 102 provides users with two primary benefits. First, it provides an absolute level of privacy in registering for the service in that they need not tell a single person what they have done. This eliminates the uncomfortable feelings associated with having to advise family, friends, or others that they have prepared a letter or other item to be delivered to someone only in the event of their death. Second, it guarantees that, in the event of their death, everything that is in a user's finished queue will be delivered without any third party having to confirm death and without the high risk of messages being sent when the user is not yet deceased.

The foregoing description of embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A processor-based method for delivering messages to recipients upon the death of a user, the method comprising the steps of:
creating user accounts, by receiving a social security number from a user computer, and storing the social security number in a first memory and in association with a given user account,
receiving recipient contact information from the user computer, and storing the contact information in a second memory and in association with the given user account,
receiving the messages to be delivered upon the death of the user from the user computer, and storing the messages in a third memory and in association with the given user account,
comparing with a processor, according to a predetermined cyclical time schedule, the social security numbers associated with the user accounts to an electronically accessible listing of social security numbers of people who have died, and
when a match is found between the social security numbers of people who have died and a social security number associated with one of the user accounts, then sending the messages associated with the user account through an output to the recipients associated with the user account.

2. The method of claim 1, wherein different messages are associated with different recipients within the user account.

3. The method of claim 1, wherein the messages include email and attachments.

4. The method of claim 1, wherein the cyclical time schedule is once per week.

5. An apparatus for delivering messages to recipients upon the death of a user, the apparatus comprising:
an input and a memory for creating user accounts, by
receiving a social security number from a user computer, and storing the social security number in association with a given user account,
receiving recipient contact information from the user computer, and storing the contact information in association with the given user account,
receiving the messages to be delivered upon the death of the user from the user computer, and storing the messages in association with the given user account,
a processor for comparing, according to a predetermined cyclical time schedule, the social security numbers associated with the user accounts to an electronically accessible listing of social security numbers of people who have died, and
an output for when a match is found between the social security numbers of people who have died and a social security number associated with one of the user accounts, sending the messages associated with the user account to the recipients associated with the user account.

6. The apparatus of claim 5, wherein different messages are associated with different recipients within the user account.

7. The apparatus of claim 5, wherein the messages include email and attachments.

8. The apparatus of claim 5, wherein the cyclical time schedule is once per week.

9. A non-transient computer-readable storage medium containing program elements for instructing a computer to deliver messages to recipients upon the death of a user, the program elements comprising instructions for:
creating user accounts, by
receiving a social security number from a user computer, and storing the social security number in a memory and in association with a given user account,
receiving recipient contact information from the user computer, and storing the contact information in a memory and in association with the given user account,
receiving the messages to be delivered upon the death of the user from the user computer, and storing the messages in a memory and in association with the given user account,
comparing, according to a predetermined cyclical time schedule, the social security numbers associated with the user accounts to an electronically accessible listing of social security numbers of people who have died, and
when a match is found between the social security numbers of people who have died and a social security number associated with one of the user accounts, then sending the messages associated with the user account to the recipients associated with the user account.

10. The storage medium of claim 9, wherein different messages are associated with different recipients within the user account.

11. The storage medium of claim 9, wherein the messages include email and attachments.

12. The storage medium of claim 9, wherein the cyclical time schedule is once per week.
